(19) United States
(12) Patent Application Publication
(10) Pub. No.: US 2009/0150115 A1
(43) Pub. Date: Jun. 11, 2009

(54) MOBILE TERMINAL DEVICE, MOBILE SPEED DETECTING METHOD USED IN THE DEVICE AND PROGRAM THEREOF

(75) Inventor: Masaru Hirata, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC Corporation, Tokyo (JP)

(21) Appl. No.: 12/065,220

(22) PCT Filed: Oct. 30, 2006
(86) PCT No.: PCT/JP2006/321624

§ 371 Date: Feb. 28, 2008

(30) Foreign Application Priority Data
Nov. 2, 2005 (JP) 2005-318968

(51) Int. Cl. G01P 3/00; G06F 15/00

(52) U.S. Cl. 702/142

(57) ABSTRACT

A mobile terminal device, which is capable of suppressing lowering of a resultant speed when speed data cannot be correctly measured by a rake receiver due to control of AFC or the like, is provided.

A comparing section 16 reads a current resultant speed out of a resultant speed storage section 18, and compares the speed data measured by the rake receiver 13 with the current resultant speed. When the speed data is faster than the current resultant speed, the filter section 17 stores the speed data as the resultant speed in the resultant speed storage section 18 as is without performing any filtering process on the speed data measured by the rake receiver 13. When the speed data is slower than the current resultant speed, the filter section 17 averages the speed data measured by the rake receiver 13 and the current resultant speed, and store the averaged speed data as the resultant speed in the resultant speed storage section 18.

### TECHNICAL FIELD

The present invention relates to a mobile terminal device, a mobile speed detecting method used in the device, and a program thereof. Particularly, the invention relates to the mobile speed detecting method in the mobile terminal device.

### BACKGROUND ART

In a mobile terminal device, it is required to measure a mobile speed of the terminal in order to change a behavior of an application used by a user depending on the mobile speed or to upgrade communication performance by notifying a base station of the mobile speed.

As a method for detecting a speed of a mobile terminal device, a method for measuring a speed using a rake receiver is known. In this case, the mobile speed is generally measured by calculating a frequency of a fading signal from a signal received by the rake receiver (for example, see Patent document 1).

In a technique described in the Patent Document 1, the mobile speed is estimated by the following equation. That is to say, a fading pitch t may be obtained according to the following equation.

t=c/(f×v) (1)

Where the mobile speed is denoted by v, a frequency to be used is denoted by f and a light speed is denoted by c. That is to say, the fading pitch t is inversely proportional to a product of the mobile speed v and the frequency f of a radio wave.

A fading frequency fd may be obtained as follows.

fd=1/t=(f×v)/c (2)

Where an inverse number of the fading pitch t is the fading frequency fd. The fading frequency fd is proportional to a product of the mobile speed v and the frequency f of a radio wave to be used. Since the frequency f to be used is known, the speed of the mobile terminal device can be estimated based on the fading pitch t (fading frequency fd). In this case, the mobile speed v may be obtained as follows.

v=(c×fd)/f (3)

In the mobile terminal device, an AFC (Auto Frequency Control) for controlling a standard frequency of the mobile terminal device based on a received signal is carried out in order to match a frequency with the standard frequency of a base station. In this case, the AFC is known as a technique to ensure a frequency error between a transmitted carrier frequency and a received standard frequency generated due to variations in products and a temperature change in radio communication.

Patent document 1: Japanese Patent Application Laid-Open No. 2000-022665

### DISCLOSURE OF THE INVENTION

### Problem to be Solved by the Invention

However, in the conventional method for detecting a speed of a mobile terminal device, a standard frequency of the mobile terminal device is controlled using a signal including a fading signal by an AFC in the case where the fading signal has a constant frequency, for example, in the case where the mobile terminal device moves toward a base station. For this reason, the mobile speed of the mobile terminal device cannot be correctly detected, and the resultant speed is low.

Here, the following equation is obtained, where a receiving frequency of the mobile terminal device is denoted by f a transmitted carrier frequency from the base station is denoted by f_{L0}, a fading frequency is denoted by fd, and a error of a local frequency of the mobile terminal device is denoted by fa.

f=f_{Lo}+fd+fa

In the case where the AFC controls the standard frequency of the mobile terminal using a signal including the fading signal, the AFC works to cancel the above fading frequency fd and the local frequency error fa of the mobile terminal device. Thus, the mobile speed of the mobile terminal device cannot be obtained because of the canceling of the fading frequency. That is to say, since the mobile speed of the mobile terminal device is detected as 0, the resultant speed becomes low.

Therefore, it is an object of the present invention to solve the above problem and to provide a mobile terminal device capable of suppressing the lowering of a resultant speed when speed data cannot be correctly measured by a rake receiver according to control such as an AFC, a mobile speed detecting method used in the device and a program thereof.

### Means for Solving the Problems

A mobile terminal device of the present invention is a mobile terminal device including a measuring unit for measuring a mobile speed, including: a resultant speed calculating unit which performs an arithmetic operation on a measurement result of the measuring unit so as to calculate a resultant speed; and a comparing unit which compares the measurement result of the measuring unit with the resultant speed calculated by the resultant speed calculating unit just before the measurement result, wherein the resultant speed calculating unit performs the arithmetic operation on the measurement result based on the comparison result of the comparing unit.

A mobile speed detecting method of the present invention is a mobile speed detecting method used in a mobile terminal device including a measuring unit for measuring a mobile speed, wherein the mobile terminal device executes a resultant speed calculating process for performing an arithmetic operation on a measurement result of the measuring unit so as to calculate a resultant speed, and a comparing process for comparing the measurement result of the measuring unit with the resultant speed calculated in the resultant speed calculating process just before the measurement result, and in the resultant speed calculating process, the arithmetic operation is performed on the measurement result based on the comparison result of the comparing process.

A program of a mobile speed detecting method of the present invention is a program of a mobile speed detecting method used in a mobile terminal device including a measuring unit for measuring a mobile speed, which allows a computer of the mobile terminal device to execute: a resultant speed calculating process for performing an arithmetic operation on a measurement result of the measuring unit so as to calculate a resultant speed; and a comparing process for comparing the measurement result of the measuring unit with the resultant speed calculated in the resultant speed calculating process just before the measurement result, wherein in the resultant speed calculating process, the arithmetic operation is performed on the measurement result based on the comparison result of the comparing process.

That is to say, the mobile terminal device of the present invention is capable of accurate speed measurement by changing a filter factor for detecting the mobile speed of the mobile terminal device (the filter factor for averaging the speed data measured by a rake receiver and the resultant mobile speed detected just before the measurement) depending on a speed state measured by the rake receiver based on a fading signal.

For more specific description, in the mobile terminal device of the present invention, the speed data measured by the rake receiver is compared with the current resultant speed detected just before the measurement, so that the comparison result showing whether the speed data is faster or slower than the current resultant speed is obtained. When the comparison result shows that the speed data is faster, the speed data is used as the resultant data as is without performing any filtering process at a filter section. And, when the comparison results shows that the speed data is slower, the filter section averages the current resultant speed and the speed data so as to obtain the resultant speed.

As a result, in the mobile terminal device of the present invention, the lowering of the resultant speed can be suppressed even if a fading signal cannot be calculated by control of the AFC (Auto Frequency Control) or the like by averaging the resultant speed.

### EFFECTS OF THE INVENTION

The present invention produces an effect such that lowering of the resultant speed can be suppressed when the speed data cannot be correctly measured by a rake receiver due to control of the AFC or the like by having the following configuration and operation.

### BEST MODE FOR CARRYING OUT THE INVENTION

An exemplary embodiment of the present invention is described below with reference to drawings. FIG. 1 is a block diagram illustrating a configuration of a mobile terminal device according to an exemplary embodiment of the present invention. In FIG. 1, the mobile terminal device 1 includes a radio section 12 connected to an antenna 11, a rake receiver 13 which obtains a base band signal from the radio section 12, an AFC (Auto Frequency Control) 14 which measures an error of a standard frequency between a base station (not shown) and the mobile terminal device 1, a standard frequency transmitter 15 in which a frequency is controlled by the AFC 14, a comparator 16 which compares speed data measured by the rake receiver 13 with a current resultant speed detected just before the measurement, a filter section 17 which averages the speed data and the current resultant speed based on the comparison result so as to obtain a resultant speed, and a resultant speed storage section 18 which stores the resultant speed obtained by the filter section 17.

FIG. 2 is a flow chart illustrating a measuring operation for the mobile speed in the mobile terminal device 1 according to the embodiment of the present invention. The measuring operation for the mobile speed in the mobile terminal device 1 is described with reference to FIGS. 1 and 2. Here, the process shown in FIG. 2 may be performed by a CPU (central processing unit) (not shown), which is a component of the mobile terminal device 1, executing a program.

The mobile terminal device 1 calculates a frequency of a fading signal from a signal received by the rake receiver 13 (step S1 in FIG. 2), and measures the mobile speed based on the calculated frequency of the fading signal (step S2 in FIG. 2). This mobile speed may be estimated by the above equation (3), and the estimated value is output as the measured speed data from the rake receiver 13.

The comparing section 16 reads a current resultant speed detected just before the measurement out of the resultant speed storage section 18 (step S3 in FIG. 2), compares the speed data measured by the rake receiver 13 with the current resultant speed (step S4 in FIG. 2), and outputs the comparison result showing whether the speed data is faster or slower than the current resultant speed to the filter section 17 (step S5 in FIG. 2).

When the comparison result by the comparing section 16 shows that the speed data is faster (step S6 in FIG. 2), the filter section 17 stores the speed data as the resultant speed in the resultant speed storage section 18 as is without performing any filtering process on the speed data measured by the rake receiver 13 (step S7 in FIG. 2).

When the comparison result by the comparing section 16 shows that the speed data is slower (step S6 in FIG. 2), the filter section 17 averages the speed data measured by the rake receiver 13 and the current resultant speed (step S8 in FIG. 2), and stores the averaged speed data as the resultant speed in the resultant speed storage section 18 (step S9 in FIG. 2).

The filtering process by the filter section 17 is generally executed according to the following equation.

resultant speed=speed data*λ+current resultant speed*(1−λ) (4)

Here, λ represents a factor of the filter. When the comparison result of the comparing section 16 shows that the speed data is slower, the factor λ of the filter may be set to 0.1, for example, so that the speed data and the current resultant speed can be averaged weighing more on the current resultant speed. The factor of the filter can be set arbitrarily depending on the comparison result of the comparing section 16.

As a result, in this embodiment, the lowering of the resultant speed can be suppressed even if the fading signal is canceled by the control of the AFC 14 or the like and thus the frequency of the fading signal cannot be calculated, by averaging the resultant speed at the filter section 17.

In this embodiment, the lowering of resultant speed can be suppressed even if the speed data in the rake receiver 13 cannot be correctly measured by the control of the AFC 14 or the like in the case where the mobile terminal device 1 moves toward the base station, by averaging the resultant speed at the filter section 17.

In the present invention, in the operation in the filter section 17, when the comparison result is faster, the speed data may be calculated with varied filter coefficient value A rather than using the speed data as is (for example, λ in the equation (4) may be set to “0.9”) so that a similar effect can be obtained. The factor λ of the filter is generally set satisfying “λ in the case of the comparison result is slower <λ in the case of the comparison result is faster”.

In the present invention, the resultant speed calculated in the above processing operation can be used for changing the behavior of an application used by a user or for improving the communication performance by notifying the base station of the mobile speed. For example, the present invention can be used for techniques such as to make a searching speed of the base station changeable depending on the resultant speed calculated in the above processing operation.

### BRIEF DESCRIPTION OF THE DRAWINGS

FIG. 1 is a block diagram illustrating a configuration of a mobile terminal device according to an exemplary embodiment of the present invention; and

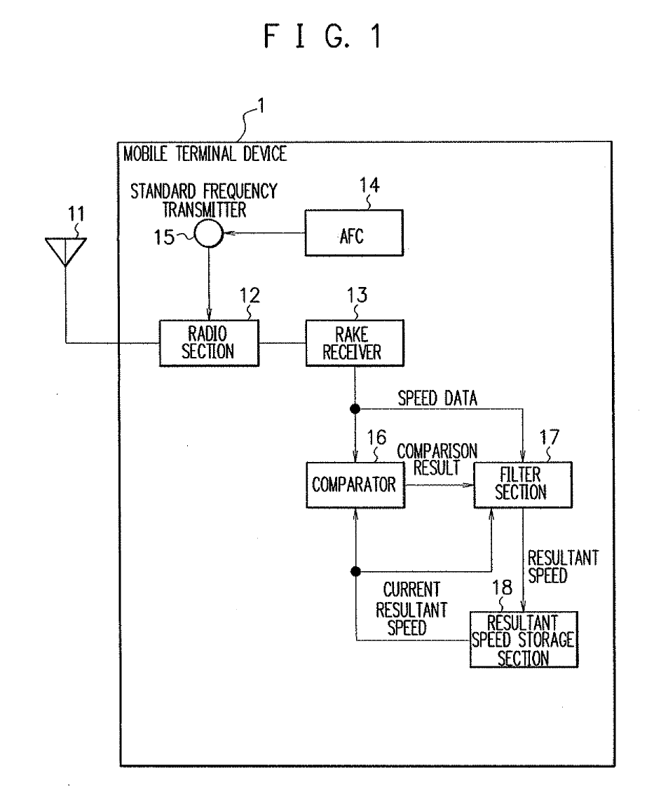

FIG. 2 is a flow chart illustrating an operation for measuring a mobile speed in the mobile terminal device according to an exemplary embodiment of the present invention.

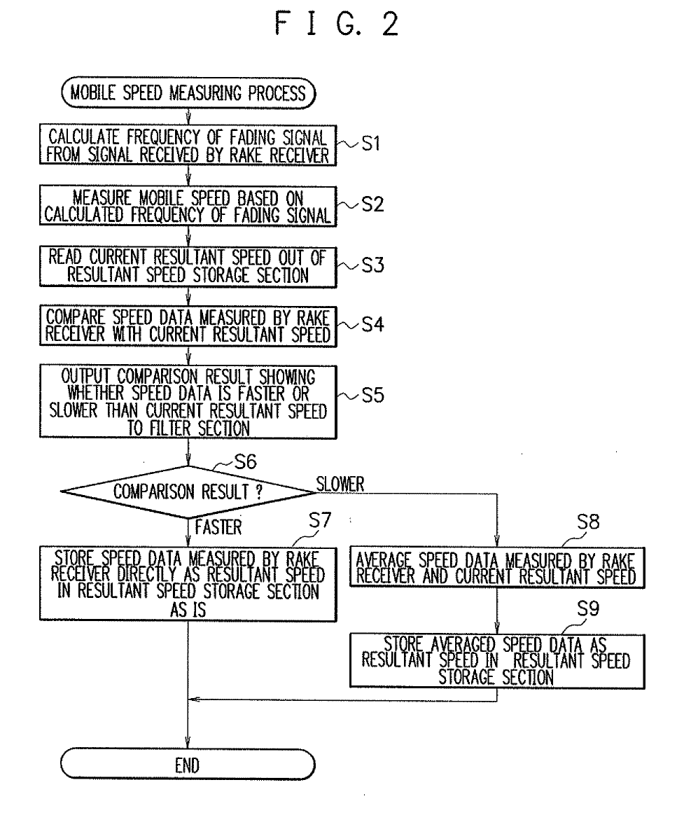

### DESCRIPTION OF REFERENCE NUMERALS

1: mobile terminal device
11: antenna
12: radio section
13: rake receiver
14: AFC
15: standard frequency transmitter
16: comparator
17: filter section
18: resultant speed storage section

1. A mobile terminal device including a measuring unit for measuring a mobile speed, comprising:
a resultant speed calculating unit which performs an arithmetic operation on a measurement result of the measuring unit so as to calculate a resultant speed; and
a comparing unit which compares the measurement result of the measuring unit with the resultant speed calculated by the resultant speed calculating unit just before the measurement result,
wherein the resultant speed calculating unit performs the arithmetic operation on the measurement result based on the comparison result of the comparing unit.

2. The mobile terminal device according to claim 1, comprising:
a storage unit which stores the resultant speed calculated by the resultant speed calculating unit,
wherein the resultant speed calculating unit averages the measurement result of the measuring unit and the resultant speed stored in the storage unit according to the comparison result of the comparing unit.

3. The mobile terminal device according to claim 1, wherein the measuring unit measures the mobile speed based on a received fading signal.

4. The mobile terminal device according to claim 2, wherein the resultant speed calculating unit executes a filtering process on the measurement result of the measuring unit and the resultant speed stored in the storage unit using a filter factor depending on the comparison result of the comparing unit so as to average the measurement result of the measuring unit and the resultant speed stored in the storage unit.

5. The mobile terminal device according to claim 4, wherein the resultant speed calculating unit uses the measurement result as the resultant speed as is without performing any filtering process when the comparing unit detects that the measurement result is faster than the resultant speed stored in the storage unit.

6. The mobile terminal device according to claim 4, wherein the resultant speed calculating unit uses the average value of the measurement result of the measuring unit and the resultant speed stored in the storage unit, which are obtained by the filtering process, as the resultant speed when the comparing unit detects that the measurement result is slower than the resultant speed stored in the storage unit.

7. A mobile speed detecting method used in a mobile terminal device including a measuring unit for measuring a mobile speed, wherein
the mobile terminal device executes a resultant speed calculating process for performing an arithmetic operation on a measurement result of the measuring unit so as to calculate a resultant speed, and a comparing process for comparing the measurement result of the measuring unit with the resultant speed calculated in the resultant speed calculating process just before the measurement result, and
in the resultant speed calculating process, the arithmetic operation is performed on the measurement result based on the comparison result of the comparing process.

8. The mobile speed detecting method according to claim 7, wherein
the mobile terminal device executes a storing process for storing the resultant speed calculated by the resultant speed calculating unit in a storage unit,
in the resultant speed calculating process, the measurement result of the measuring unit and the resultant speed stored in the storage unit are averaged depending on the comparison result of the comparing process.

9. The mobile speed detecting method according to claim 7, wherein the measuring unit measures the mobile speed based on a received fading signal.

10. The mobile speed detecting method according to claim 8, wherein in the resultant speed calculating process, a filtering process is executed on the measurement result of the measuring unit and the resultant speed stored in the storage unit using a filter factor depending on the comparison result of the comparing process.

11. The mobile speed detecting method according to claim 10, wherein in the resultant speed calculating process, the measurement result is used as the resultant speed as is without performing any filtering process when the detection is made that the measurement result is faster than the resultant speed stored in the storage unit in the comparing process.

12. The mobile speed detecting method according to claim 10, wherein in the resultant speed calculating process, the average value of the measurement result of the measuring unit and the resultant speed stored in the storage unit, which are obtained by the filtering process, is used as the resultant speed when the detection is made that the measurement result is slower than the resultant speed stored in the storage unit in the comparing process.

13. A computer-readable medium storing a program of a mobile speed detecting method used in a mobile terminal device including a measuring unit for measuring a mobile speed, which allows a computer of the mobile terminal device to execute: a resultant speed calculating process for performing an arithmetic operation on a measurement result of the measuring unit so as to calculate a resultant speed; and a comparing process for comparing the measurement result of the measuring unit with the resultant speed calculated in the resultant speed calculating process just before the measurement result,
wherein in the resultant speed calculating process, the arithmetic operation is performed on the measurement result based on the comparison result of the comparing process.
